(19) United States
(12) Patent Application Publication
(10) Pub. No.: US 2011/0188969 A1
(43) Pub. Date: Aug. 4, 2011

(54) Captive Hardware

(75) Inventors: Joseph A. Michalic, Elburn, IL (US); Rudolph J. Lang, III, St. Charles, IL (US)

(73) Assignee: MacLean-Fogg Company, Mundelein, IL (US)

(21) Appl. No.: 12/696,461

(22) Filed: Jan. 29, 2010

(51) Int. Cl. F16B 37/08

(52) U.S. Cl. 411/433

(57) ABSTRACT

Captive fasteners are provided that may be used with guards that cover particular areas of a machine. The fasteners are attached to the guards so that they remain with the guard when the guard is removed from the machine. In order to make it easier to reinstall the guard onto a machine when the guard is misaligned, the fasteners can move along a slotted opening in the guard.

### BACKGROUND

The present invention relates generally to fasteners and more particularly to captured hardware.

Fasteners are used in numerous applications to attach various components together. Typically, a fastener has at least a threaded portion and a plurality of bearing surfaces attached thereto. The bearing surfaces are designed to receive torque from a tool, such as a socket or wrench, which is used to tighten or loosen the fastener. In a conventional fastener, such as a nut, the fastener may have internal threads and six bearing surfaces oriented in a hexagonal shape around the internal threads. Other fasteners may have external threads, such as a screw. Fasteners may also have numerous types of bearing surfaces, including external heads with four, eight or any other number of side bearing surfaces and internal bearing surfaces, such as screw driver straight blades or Phillips drive surfaces.

One application that fasteners are used for his attaching operator guards on various types of machines and other apparatus to prevent an operator from accessing particular areas of the machine during operation or to protect such areas of the machine from coming into contact with foreign objects during use. Typically, machines are designed with certain areas that require frequent access for maintenance or other reasons. However, when the machine is in operation, it may be desirable to prevent access to these areas because of safety concerns or other reasons. To address these needs, manufacturers of machinery often provide removable guards, or other apparatus, to cover particular areas of the machine. Normally, these guards are attached to the machine with various types of fasteners with conventional bearing surfaces. Thus, when an operator needs to gain access to a particular area covered by the removable guard, the operator can use a conventional torque tool to loosen the fasteners and remove the guard from the covered area. After the operator has finished whatever work is needed within the guarded area, the operator reinstalls the guard in the original location on the machine and tightens the fasteners to reattach the guard.

Although guards may be attached to a machine in numerous ways, one common attachment design includes a pattern of nuts that have been welded to the frame of the machine. The guards may have a pattern of holes through the guard that matches the pattern of welded nuts. The guard may then be positioned against the machine frame so that the holes in the guard lineup with the welded nuts. Conventional screws can then be inserted through the holes in the guard and tightened into the welded nuts to secure the guard to the machine. Alternatively, the machine may be provided with permanently attached threaded studs that extend out toward the guard. The guard may then be placed over the studs so that the studs extend through the holes in the guard. In this arrangement, conventional nuts may be tightened onto the studs to secure the guard onto the machine.

In some cases, it may be desirable to provide slotted openings in the guard instead of round holes. The primary reason for using slotted openings is to make it easier for an operator to remove and reinstall the guard onto the machine frame. Round holes through the guard can make it difficult and time-consuming to remove and reinstall a guard onto a machine when the pattern of holes through the guard do not closely match the pattern of nuts or studs attached to the machine. This situation can occur for a number of reasons, such as dimensional variations that occur during manufacturing and bending or deformation that can occur during use of the machine to the machine frame, the permanently attached nuts or studs or to the guard. Lining up the holes in the guard to the nuts or studs attached to the machine also becomes increasingly more challenging when the number of fasteners is increased. For example, a guard that uses eight fasteners and eight corresponding guard holes and welded nuts will typically be significantly more difficult to line up and attach than a guard that only uses two fasteners and two corresponding guard holes and welded nuts. Slotted openings through the guard greatly reduce the difficulty and time required to remove and reinstall a guard by providing a greater range of positions that the guard can be lined up to the machine frame and still permit the fasteners to engage the permanently attached to nuts or studs through the guard openings.

The fasteners that are used to attach a guard to a machine oftentimes are conventional fasteners that are separate from the guard and the machine. This is a common choice when designing a guard and attachment arrangement because it is simple to manufacture and easy to use. However, there are several problems with the use of loose fasteners that are not attached in any way to the guard. One common problem with this design is that the fasteners can be lost by the operator when the guard is removed for maintenance within the guarded area. When this occurs, the operator may be forced to stop using the machine until replacement fasteners are acquired. This can be expensive because operational time with the machine is lost while the operator searches for the lost fasteners or new fasteners are procured. If the fasteners are special fasteners that must be purchased from the manufacturer or other specialty supplier, the replacement fasteners may also be costly to purchase. In addition, there is a risk that the lost fasteners may fall into mechanisms of the machine. Potentially, this can cause even more damage to the machine if the lost fasteners become entangled with moving parts of the machine. Alternatively, an operator may choose to continue using the machine without the guard in place to avoid the time and expense involved in replacing the lost fasteners. However, this can be dangerous if the guard is designed to protect the operator from moving or hot parts within the guarded area. On the other hand, if the guard is designed to protect an area of the machine from coming into contact with foreign objects during use, the operator risks damaging the machine or causing other damage by operating machine without the guard in place.

Accordingly, the inventor believes it would be desirable to provide a fastener that can be attached to a guard or other apparatus and is movable along a slot in the guard or apparatus.

### SUMMARY

Captured fasteners are described that may be attached to an apparatus, such as a guard. The fasteners may be provided with internal threads, such as a nut, or with external threads, such as a screw. The fasteners are provided with a sleeve that has a slot that corresponds to a slot in the guard. Therefore, the nut or screw can move along the length of the slot to make it easier to attach the guard to a machine. Additional details and advantages are described below in the detailed description.

The invention may include any of the following aspects in various combinations and may also include any other aspect described below in the written description or in the attached drawings.

A fastener, comprising:

a plurality of wrench bearing surfaces;
a threaded portion coaxial with and rotationally fixed to the wrench bearing surfaces;
a first torque bearing surface rotationally fixed to the wrench bearing surfaces;
a sleeve comprising an attachment surface adapted to fixedly attach the sleeve to an apparatus, a second torque bearing surface oppositely disposed from the attachment surface, a slotted opening extending through the second torque bearing surface, and an undercut space larger in size than the slotted opening disposed under the slotted opening between the second torque bearing surface and the attachment surface, the second torque bearing surface being larger in size than the slotted opening and being adapted to engage the first torque bearing surface;
an insert portion extending through the slotted opening, the insert portion being coaxial with the wrench bearing surfaces, the insert portion being approximately equal in size to a width of the slotted opening to minimize lateral movement of the insert portion within the slotted opening, and the insert portion being smaller in size to a length of the slotted opening to allow movement of the insert portion along the length of the slotted opening;
a retaining member longitudinally restrained to the wrench bearing surfaces when the wrench bearing surfaces are moved longitudinally and not rotated, the retaining member disposed within the undercut space and being larger in size than a width of the slotted opening;
wherein the wrench bearing surfaces, the threaded portion, the first torque bearing surface, and the insert portion are prevented from being separated from the sleeve by the retaining member when the wrench bearing surfaces are not rotated, and longitudinal force is transmitted to the apparatus through the first torque bearing surface, the second torque bearing surface, the sleeve and the attachment surface when the wrench bearing surfaces are tightened.

The fastener wherein the wrench bearing surfaces, the threaded portion, the first torque bearing surface, the insert portion and the retaining member comprise an integral nut, the threaded portion comprising internal threads.

The fastener further comprising a washer disposed within the undercut space between the retaining member and the slotted opening and being larger in size than the width of the slotted opening.

The fastener wherein the retaining member is a flange on an inner sleeve, the inner sleeve being longitudinally restrained to the wrench bearing surfaces when the wrench bearing surfaces are moved longitudinally and not rotated.

The fastener wherein the inner sleeve comprises inner threads, the threaded portion of the screw being threadable through the inner threads of the inner sleeve.

The fastener wherein the wrench bearing surfaces, the threaded portion and the first torque bearing surface comprise an integral screw, the threaded portion comprising external threads, the screw further comprising a shaft portion disposed between the first torque bearing surface and the threaded portion, the shaft portion being smaller in diameter than the inner threads of the inner sleeve, the shaft portion thereby being slidable through the inner threads.

The fastener wherein the inner sleeve comprises a contact surface at a first end of the inner sleeve disposed away from the first torque bearing surface, the contact surface being adapted to contact a surface of the apparatus when the sleeve is fixedly attached to the apparatus, the contact surface being larger in size than a width of an apparatus slotted opening extending through the apparatus which the fastener is adapted for, the inner sleeve thereby being prevented from extending through the apparatus slotted opening when the sleeve is fixedly attached to the apparatus.

The fastener wherein a width of the contact surface is approximately equal in size to a width of the undercut space to minimize lateral movement of the inner sleeve within the sleeve.

The fastener wherein a length between the contact surface and a second end of the inner sleeve disposed toward the first torque bearing surface is at least as long as a distance between the attachment surface and the slotted opening, an end portion of the inner sleeve adjacent the second end thereby protruding through at least a portion of the slotted opening when the contact surface contacts the surface of the apparatus, the end portion forming the insert portion.

The fastener wherein the end portion comprises opposing flat sides engaged with the width of the slotted opening, the inner sleeve thereby being rotationally fixed to the sleeve.

The fastener wherein the end portion extends along a length of the inner sleeve greater than a depth of the slotted opening, the end portion thereby being slidable through the slotted opening and the second end of the inner sleeve being extendable past the second torque bearing surface, the opposing flat sides extending an entire length that the end portion is slidable through the slotted opening.

The fastener wherein the flange is disposed at the first end of the inner sleeve thereby forming the contact surface and the end portion extends from the second end to the flange.

The fastener wherein the inner threads of the inner sleeve are disposed adjacent the second end, the inner sleeve further comprising an internal portion disposed from the inner threads to the first end and being larger in size than the threaded portion, the threaded portion thereby being slidable through the internal portion.

The fastener wherein a combined length of the shaft portion and the end portion is within a 25% range of a length of the threaded portion.

The fastener wherein the threaded portion comprises external threads and the retaining member is a flange on an inner sleeve, the inner sleeve being longitudinally restrained to the wrench bearing surfaces when the wrench bearing surfaces are moved longitudinally and not rotated, the inner sleeve comprising a contact surface at a first end of the inner sleeve disposed away from the first torque bearing surface, the contact surface being adapted to contact a surface of the apparatus when the sleeve is fixedly attached to the apparatus, a length between the contact surface and a second end of the inner sleeve disposed toward the first torque bearing surface being at least as long as a distance between the attachment surface and the slotted opening, and an end portion of the inner sleeve adjacent the second end thereby protruding through at least a portion of the slotted opening when the contact surface contacts the surface of the apparatus, the end portion forming the insert portion, the end portion comprising opposing flat sides engaged with the width of the slotted opening, the inner sleeve thereby being rotationally fixed to the outer sleeve, the end portion extending along a length of the inner sleeve greater than a depth of the slotted opening, the end portion thereby being slidable through the slotted opening and the second end of the inner sleeve being extendable past the second torque bearing surface, and the opposing flat sides extending an entire length that the end portion is slidable through the slotted opening.

The fastener wherein the wrench bearing surfaces, the threaded portion and the first torque bearing surface comprise an integral screw, the inner sleeve comprising inner threads, the threaded portion of the screw being threadable through the inner threads of the inner sleeve.

The fastener wherein the screw further comprises a shaft portion disposed between the first torque bearing surface and the threaded portion, the shaft portion being smaller in diameter than the inner threads of the inner sleeve, the shaft portion thereby being slidable through the inner threads, the inner threads of the inner sleeve being disposed adjacent the second end, the inner sleeve further comprising an internal portion disposed from the inner threads to the first end and being larger in size than the threaded portion, the threaded portion thereby being slidable through the internal portion.

The fastener wherein a combined length of the shaft portion and the end portion is within a 25% range of a length of the threaded portion.

The fastener wherein the threaded portion comprises external threads and the retaining member is a flange on an inner sleeve, the inner sleeve being longitudinally restrained to the wrench bearing surfaces when the wrench bearing surfaces are moved longitudinally and not rotated, the inner sleeve comprising a contact surface at a first end of the inner sleeve disposed away from the first torque bearing surface, the contact surface being adapted to contact a surface of the apparatus when the sleeve is fixedly attached to the apparatus, the contact surface being larger in size than a width of an apparatus slotted opening extending through the apparatus which the fastener is adapted for, the inner sleeve thereby being prevented from extending through the apparatus slotted opening when the sleeve is fixedly attached to the apparatus, a width of the contact surface being approximately equal in size to a width of the undercut space to minimize lateral movement of the inner sleeve within the sleeve.

The fastener wherein a length between the contact surface and a second end of the inner sleeve disposed toward the first torque bearing surface is at least as long as a distance between the attachment surface and the slotted opening, an end portion of the inner sleeve adjacent the second end thereby protruding through at least a portion of the slotted opening when the contact surface contacts the surface of the apparatus, the end portion forming the insert portion and comprising opposing flat sides engaged with the width of the slotted opening, the inner sleeve thereby being rotationally fixed to the sleeve, the end portion extending along a length of the inner sleeve greater than a depth of the slotted opening, the end portion thereby being slidable through the slotted opening and the second end of the inner sleeve being extendable past the second torque bearing surface, the opposing flat sides extending an entire length that the end portion is slidable through the slotted opening, the inner sleeve further comprising inner threads, the threaded portion of the screw being threadable through the inner threads of the inner sleeve, and further comprising a shaft portion disposed between the first torque bearing surface and the threaded portion, the shaft portion being smaller in diameter than the inner threads of the inner sleeve, the shaft portion thereby being slidable through the inner sleeve, the inner threads of the inner sleeve being disposed adjacent the second end, the inner sleeve further comprising an internal portion disposed from the inner threads to the first end and being larger in size than the threaded portion, the threaded portion thereby being slidable through the internal portion.

### BRIEF DESCRIPTION OF SEVERAL VIEWS OF THE DRAWINGS

The invention may be more fully understood by reading the following description in conjunction with the drawings, in which:

FIG. 1 is a top perspective view of a nut intended to be fixedly attached to an apparatus;

FIG. 2 is a bottom perspective view of the nut;

FIG. 3 is a cross-sectional view of the nut, showing the width of the slot in the sleeve;

FIG. 4 is a cross-sectional view of the nut, showing the length of the slot in the sleeve;

FIG. 5 is a cross-sectional view of a screw intended to be fixedly attached to an apparatus, showing the width of the slot in the sleeve;

FIG. 6A is a top plan view of a sleeve and inner sleeve;

FIG. 6B is a perspective view of the sleeve and the inner sleeve, showing the inner sleeve fully collapsed within the sleeve;

FIG. 6C is a perspective view of the sleeve and the inner sleeve, showing the inner sleeve fully telescoped through the slotted opening in the sleeve;

FIG. 7 is a cross-sectional view of the screw, showing the length of the slot in the sleeve;

FIG. 8 is a bottom perspective view of the screw;

FIG. 9 is a cross-sectional perspective view of the screw, showing the screw and inner sleeve telescoped out of the sleeve;

FIG. 10 is a cross-sectional perspective view of the screw, showing the screw telescoped out of the sleeve and the inner sleeve completely within the sleeve;

FIG. 11 is a cross-sectional perspective view of the screw, showing the screw with a reduced body diameter bolt and an outer sleeve and the guard attached to a machine; and

FIG. 12 is a top perspective view of the screw, showing the screw with a captive inner sleeve (not visible) attached to a guard.

### DETAILED DESCRIPTION

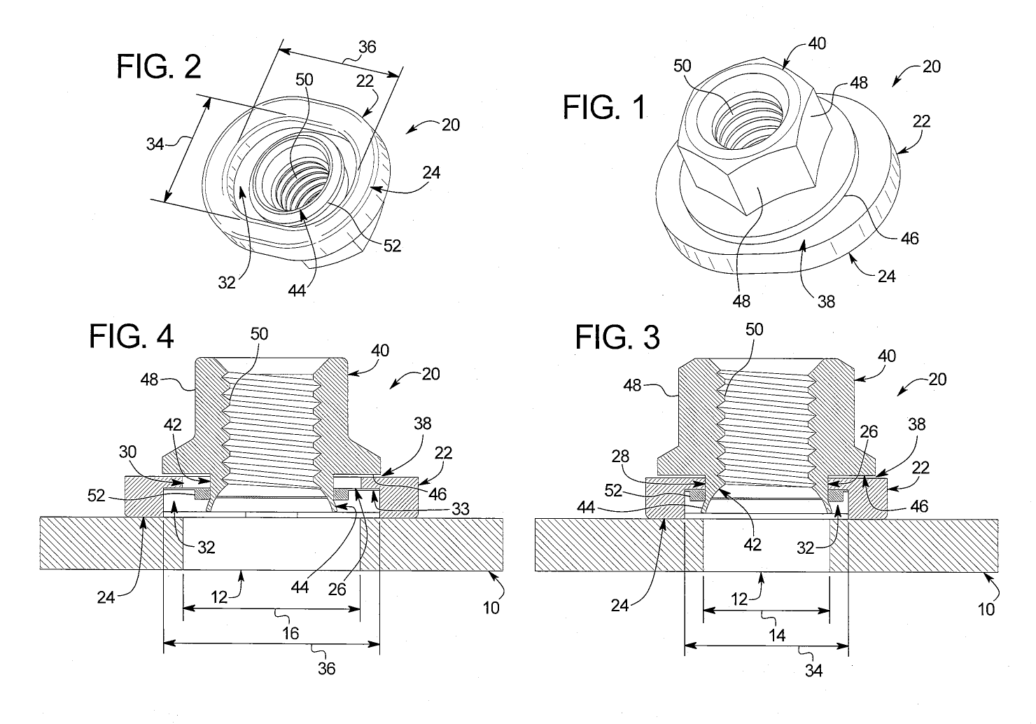

Referring now to the figures, and particularly to FIGS. 1-4, a nut fastener 20 is shown. The nut fastener 20 is designed to provide a captured nut 40 that may be attached to an apparatus 10, such as a guard 10. As shown in FIGS. 3-4, the nut fastener 20 may include a sleeve 22 that is permanently attached to a guard 10 by welding the attachment surface 24 of the sleeve 22 to the guard 10. The sleeve 22 may be welded to the guard 10 either by welding around the outer circumference of the sleeve 22 or providing weld nubs 65 on the attachment surface 24 of the sleeve 22 (as shown in FIG. 8). When weld nubs 65 are provided, the sleeve 22 may be attached to the guard 10 by simultaneously pressing the sleeve 22 against the guard 10 and applying electrical current to the sleeve 22. This causes the weld nubs 65 to melt into the surface of the guard 10 and welds the sleeve 22 and guard 10 together. The guard 10 may be provided with a slotted opening 12 which a threaded stud may be inserted through. Typically, the threaded stud will be permanently attached to a machine, and the apparatus 10 that the nut fastener 20 is attached to will be a guard 10 designed to cover a particular area of the machine. The slotted opening 12 in the guard 10 typically has a width 14 that is approximately the same size of the threaded stud attached to the machine to minimize lateral movement between the guard 10 and the threaded machines stud. However, the length 16 of the slotted opening 12 in the guard 10 is longer than the size of the threaded machine stud so that the guard 10 and the stud can move relative to each other.

The sleeve 22 also includes a slotted opening 26 that generally corresponds to the shape of the slotted opening 12 in the guard 10 so that the nut 40 can move along the length 16 of the slotted opening 26 as further described below. The size of the slotted opening 26 is the sleeve 22 may be larger than the slotted opening 12 in the guard 10 if desired to allow for the particular size of the insert portion 42 that is used. Accordingly, the slotted opening 26 in the sleeve 22 preferably has a width 28 that is approximately the same size as the insert portion 42 of the nut 40 to minimize lateral movement between the nut 40 and the sleeve 22. The length 30 of the slotted opening 26 in the sleeve 22 may be longer than the size of the insert portion 42 of the nut 40 to allow movement of the nut 40 along the length 30 of the slotted opening 26. The sleeve 22 also includes an undercut space 32 below the slotted opening 26 that is larger in size than the slotted opening 26. Preferably, the undercut space 32 extends the entire length from the slotted opening 26 in the sleeve 22 to the attachment surface 24. The undercut space 32 receives a retaining member 44 of the nut 40 which is larger than the insert portion 42 of the nut 40. The retaining member 44 is also larger than the width 28 of the slotted opening 26 in the sleeve 22. Thus, the retaining member 44 prevents the nut 40 from being separated from the sleeve 22. Although the retaining member 44 may be formed and shaped in various ways, one desirable way to make the retaining member 44 is to initially form the retaining member 44 as a straight extension of the insert portion 42. During assembly, the insert portion 42 and extended portion may be inserted through the slotted opening 26 in the sleeve 22 and the extended portion can be flared out by swaging. Preferably, the width 34 and the length 36 of the undercut space 32 are both larger than the slotted opening 26 by the same amount to accommodate the larger size of the retaining member 44 both along the width 34 and the length 36 of the undercut space 32.

The sleeve 22 further includes a second torque bearing surface 38 that is designed to engage with the first torque bearing surface 46 of the nut 40. Thus, when the nut 40 is tightened onto a threaded stud attached to a machine or other apparatus, compressive force is transmitted between the first and second torque bearing surfaces 46, 38 and through the sleeve body 22 to the attachment surface 24. The nut 40 may be provided with numerous torque bearing surfaces 48, but conventional hexagonal-shaped bearing surfaces 48 as shown in FIG. 1 may be used. The nut 40 also includes conventional internal threads 50 for engaging the external threads of a stud. A washer 52 may also be provided in the undercut space 32 between the retaining member 44 and the top 33 of the undercut space 32 to provide improved retention of the nut 40 within the sleeve 22 if desired. However, the washer 52 may be eliminated and the nut 40 may be directly swaged or staked within the undercut space 32 if a less expensive assembly is desired.

It is now apparent that the nut fastener 20 provides a nut assembly 20 that can be permanently attached to a guard 10 and provides a range of movement for the nut 40 that can correspond to a slotted opening 12 in the guard 10. As described, the sleeve 22 may be welded to the guard 10 so that the position of the slotted opening 26 in the sleeve 22 mates with the slotted opening 12 in the guard 10. This allows the nut 40 to move along the length 16 of the slotted opening 12 in the guard 10. Thus, the nut 40 can be threaded onto a threaded machine stud extending through the slotted opening 12 in the guard 10 regardless of where the threaded machine stud is located along the length 16 of the slotted opening 12. As a result, the guard 10 may be easily attached to the machine even if the guard 10 is not perfectly aligned with the machine. The nut 40 is also captured and retained onto the guard 10 to prevent the nut 40 from being dropped and/or lost when the guard 10 is removed from the machine. This makes it easier to reinstall the guard 10 and more likely that an operator will it reinstall the guard 10 before using the machine.

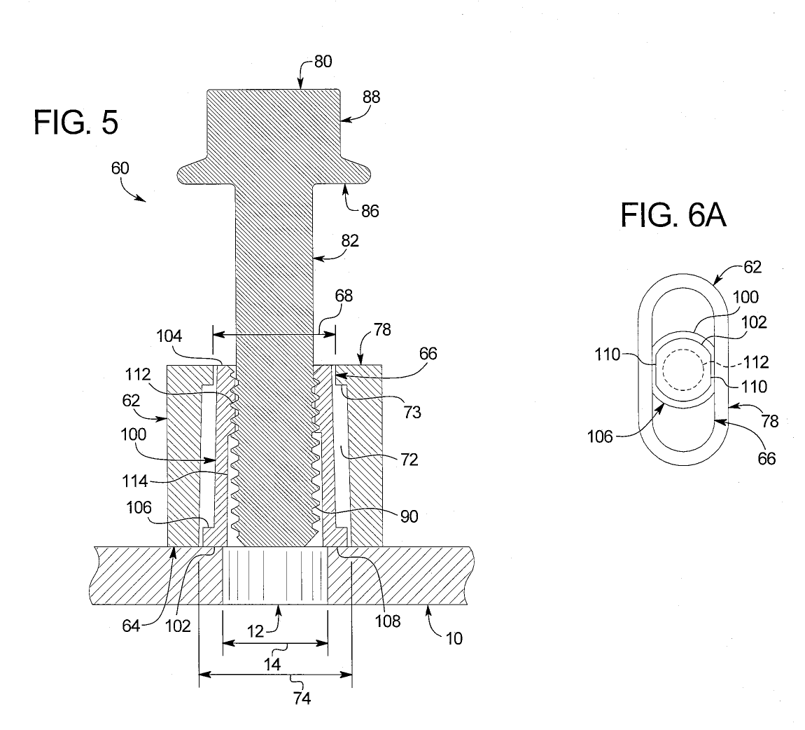

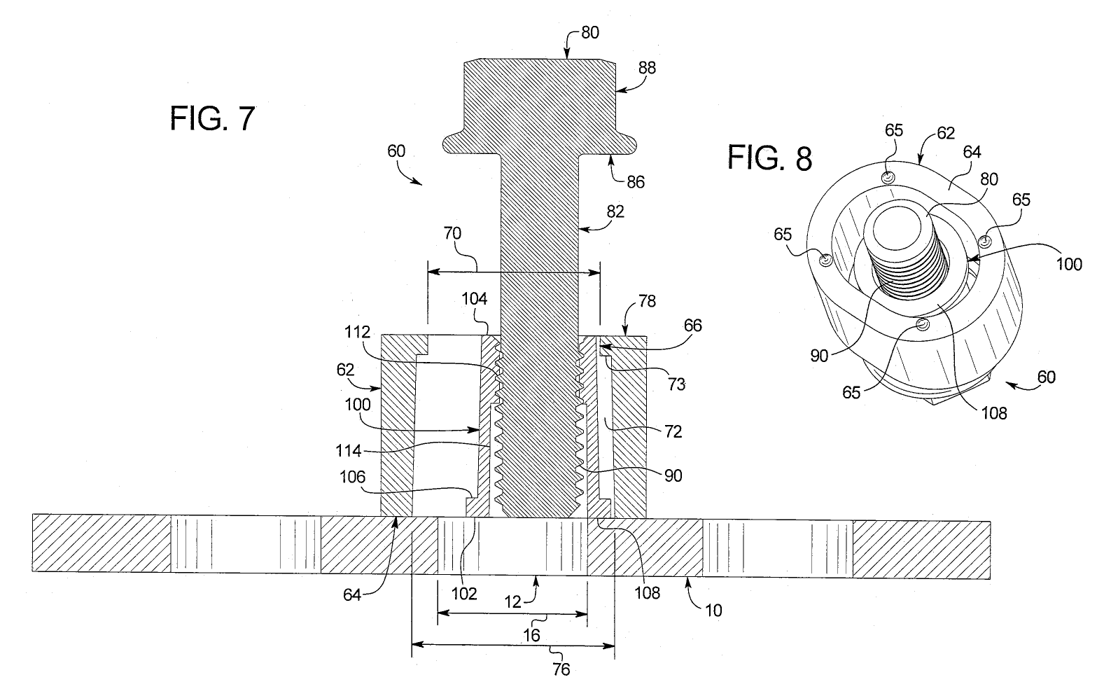

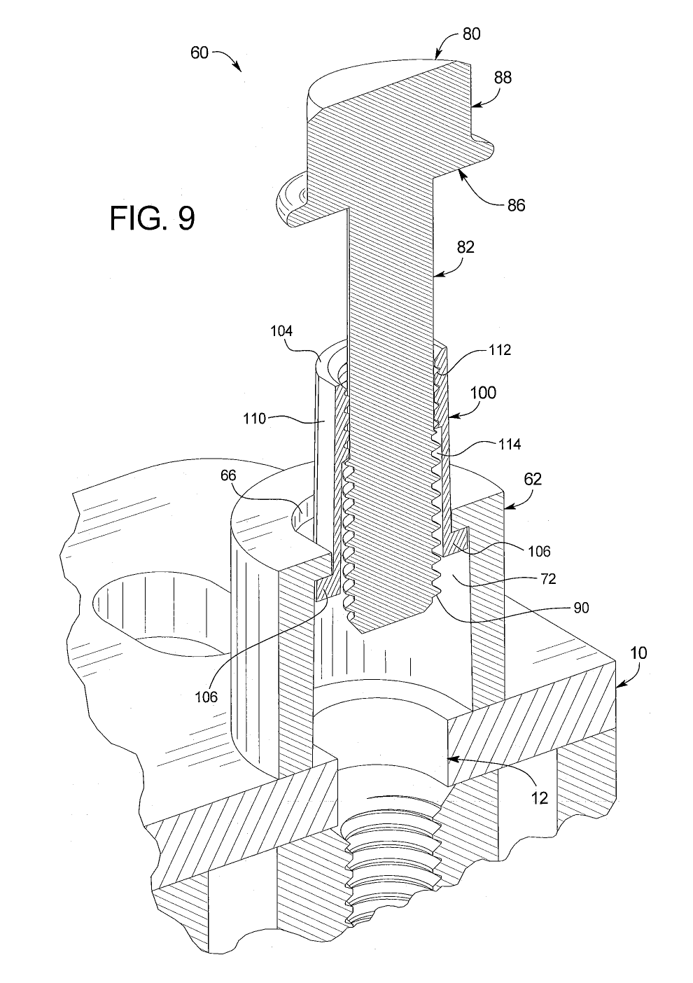

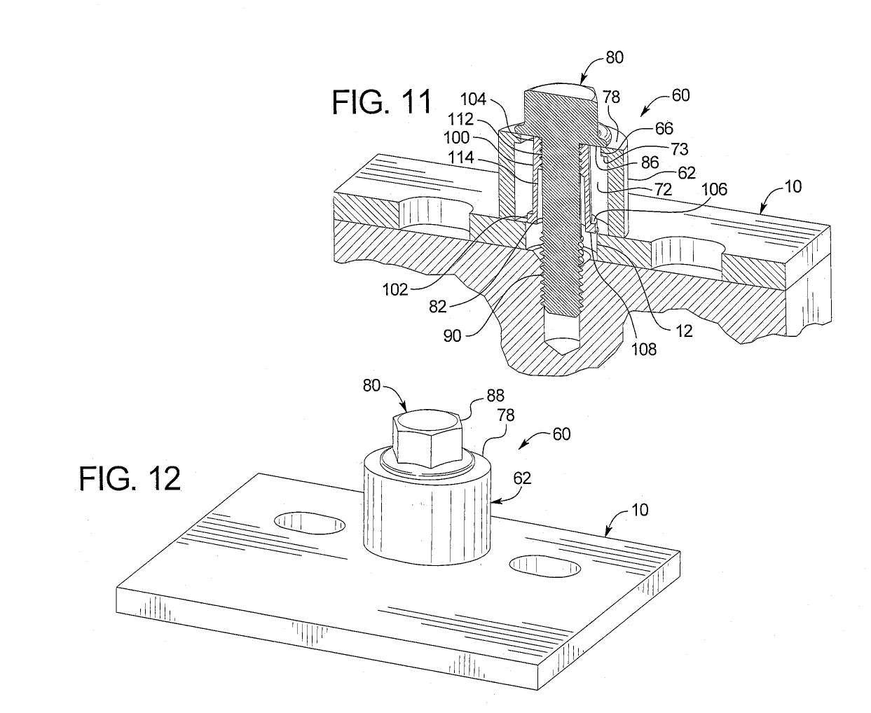

Turning to FIGS. 5-12, a screw fastener 60 is shown. The screw fastener 60 is designed to provide a captured screw 80 that may be attached to an apparatus 10, such as the guard 10 described above. Thus, in contrast to the nut fastener 20 described above, the screw fastener 60 may be used to attach a guard 10 to a machine that is provided with threaded holes or nuts that are welded to the machine instead of threaded studs. The screw fastener 60 may include a sleeve 62, or outer sleeve 62, that is permanently attached to the guard 10 by welding the attachment surface 64 of the sleeve 62 to the guard 10. The sleeve 62 may be welded to the guard 10 either by welding around the outer circumference of the sleeve 62 or providing weld nubs 65 on the attachment surface 64 of the sleeve 62 (as shown in FIG. 8). When weld nubs 65 are provided, the sleeve 62 may be attached to the guard 10 by simultaneously pressing the sleeve 62 against the guard 10 and applying electrical current to the sleeve 62. This causes the weld nubs 65 to melt into the surface of the guard 10 and welds the sleeve 62 and the guard 10 together. The guard 10 may be provided with a slotted opening 12 which may be aligned to a welded nut attached to a machine when the guard 10 is being installed onto the machine. The slotted opening 12 in the guard 10 typically has a width 14 that is approximately the same size of the threaded portion 90 of the screw 80 as shown in FIG. 5 to minimize lateral movement between the guard 10 and the screw 80. However, as shown in FIG. 7, the length 16 of the slotted opening 12 in the guard 10 is longer than the size of the threaded portion 90 of the screw 80 so that the screw 80 can move relative to the guard 10 along the slotted opening 12 when it is extended through the slotted opening 12.

The sleeve 62 also includes a slotted opening 66 that generally corresponds to the shape of the slotted opening 12 in the guard 10 so that the screw 80 can move along the length 16 of the slotted opening 12 in the guard 10. However, the size of the slotted opening 66 in the sleeve 62 may be larger than the slotted opening 12 in the guard 10 to allow for the particular size of the inner sleeve 100 that is used. The slotted opening 66 in the sleeve 62 preferably has a width 68 that is approximately the same size as the second end 104 of the inner sleeve 100 to minimize lateral movement between the screw 80 and the sleeve 62. The length 70 of the slotted opening 66 in the sleeve 62 may be larger than the size of the second end 104 of the inner sleeve 100 to allow movement of the screw 80 along the length of the slotted opening 66. The sleeve 62 also includes an undercut space 72 below the slotted opening 66 that is larger in size than the slotted opening 66. Preferably, the undercut space 72 extends the entire length from the slotted opening 66 in the sleeve 62 to the attachment surface 64. The undercut space 72 receives a retaining member 106 of the inner sleeve 100. Preferably, the width 74 and the length 76 of the undercut space 72 are both larger than the slotted opening 66 by the same amount to accommodate the larger size of the retaining member 106 both along the width 74 and the length 76 of the undercut space 72. The width of the retaining member 106 and the contact surface 108 of the inner sleeve 100 may be approximately the same size as the width 74 of the undercut space 72 to minimize lateral movement of the inner sleeve 100. The sleeve 62 further includes a second torque bearing surface 78 that is designed to engage with the first torque bearing surface 86, or flange head, of the screw 80. Thus, when the screw 80 is tightened onto a nut welded to a machine or other apparatus, compressive force is transmitted between the first and second torque bearing surfaces 86, 78 and through the sleeve body 62 to the attachment surface 64.

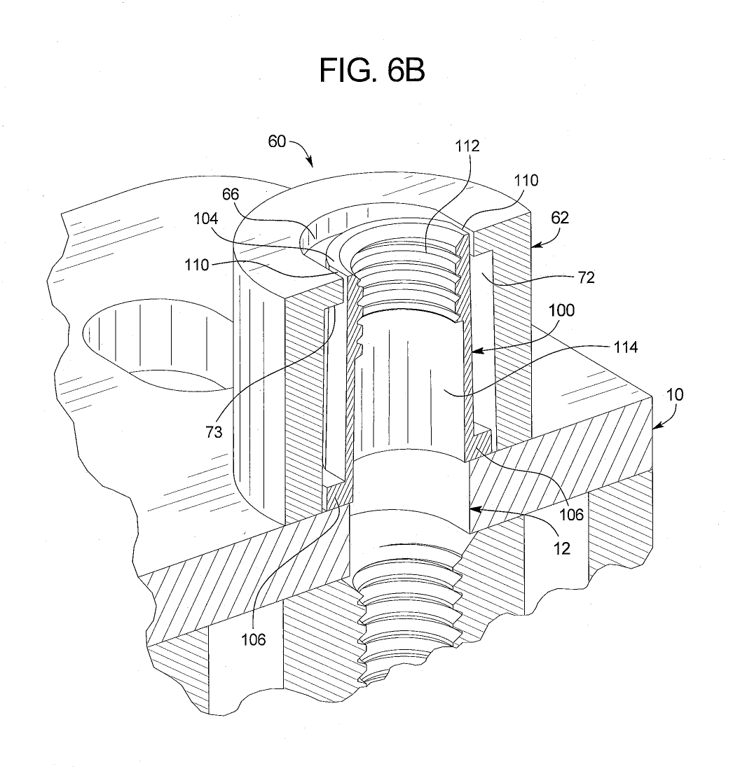

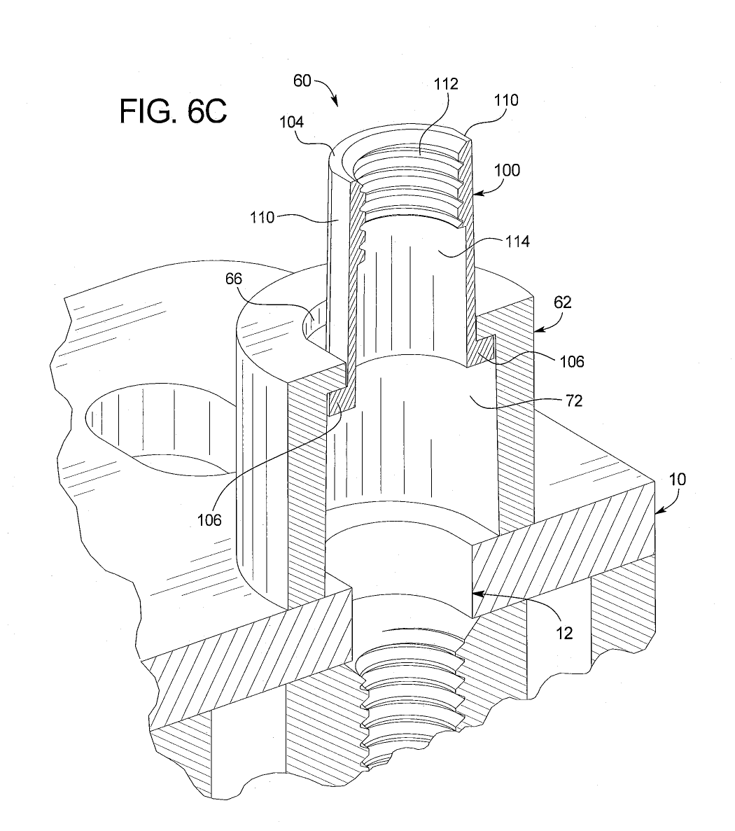

The screw fastener 60 also includes an inner sleeve 100 that is positioned within the sleeve 62. The inner sleeve 100 has a first end 102 that is located toward the attachment surface 64 of the sleeve 62 and a second end 104 that is located away from the attachment surface 64 of the sleeve 62. The retaining member 106 is larger than the second end 104 of the inner sleeve 100 and is preferably located at the first end 102 of the inner sleeve 100. Thus, as shown, the retaining member 106 may be a flange 106 at the first end 102 of the inner sleeve 100 which forms a contact surface 108 that contacts the surface of the guard 10. The retaining member 106 is also larger than the width 68 of the slotted opening 66 in the sleeve 62. Therefore, the retaining member 106 prevents the inner sleeve 100 from being separated from the sleeve 62. Preferably, the second end 104 of the inner sleeve 100 is smaller in size than the slotted opening 66 in the sleeve 62 so that the second end 104 extends at least partially through the slotted opening 66. As shown in FIGS. 6A-6C, the second end 104 may have flat sides 110 that engage the width 68 of the slotted opening 66 to prevent rotation of the inner sleeve 100 relative to the sleeve 62. If the retaining member 106 is located at the first end 102 of the inner sleeve 100, the second end 104 with flat sides 110 may extend the entire length to the retaining member 106 so that the inner sleeve 100 can slide through the slotted opening 66 until the retaining member 106 contacts the top 73 of the undercut space 72. However, the retaining member 106 may also be located at an intermediate location. Thus, the first end 102 of the inner sleeve 100 may be an end portion 102 that forms an insert portion 102 extendable through the slotted opening 66 in the sleeve 62. The inner sleeve 100 also includes inner threads 112 adjacent the first end 102 which are engageable with the external threads 90 of the screw 80. An internal portion 114 of the inner sleeve 100 may extend from the inner threads 112 to the contact surface 108 of the inner sleeve 100. Preferably, the internal portion 114 is larger in size than external threads 90 of the screw 80 so that the external threads 90 of the screw 80 do not engage the internal portion 114.

The screw 80 may be provided with numerous torque bearing surfaces 88, but conventional hexagonal-shaped bearing surfaces 88 as shown in FIG. 12 may be used. The screw 80 also includes conventional external threads 90 for engaging the internal threads of a welded nut. Preferably, the screw 80 includes a shaft portion 82 between the first torque bearing surface 86 and external threads 90 of the screw 80. The shaft portion 82 may be smaller in size than the external threads 90 of the screw 80 and the inner threads 112 of the inner sleeve 100 so that the shaft portion 82 can slide through the inner threads 112 of the inner sleeve 100.

It is now apparent that the screw fastener 60 provides a screw assembly 60 in which the sleeve 62 and inner sleeve 100 may be permanently attached to a guard 10. The screw fastener 60 provides a range of movement for the screw 80 that can correspond to a slotted opening 12 in the guard 10. As described, the sleeve 62 may be welded to a guard 10 so that the position of the slotted opening 66 in the sleeve 62 mates with the slotted opening 12 in the guard 10. This allows the screw 80 to move along the length of the slotted opening 12 in the guard 10. Thus, the screw 80 can be threaded into a threaded hole or a welded machine nut by extending the screw 80 through the slotted opening 12 in the guard 10 regardless of where the welded machine nut is located along the length 16 of the slotted opening 12. As a result, the guard 10 may be easily attached to the machine even if the guard 10 is not perfectly aligned with the machine. The screw 80 is also captured and retained onto the guard 10 to prevent the screw 80 from being dropped and/or lost when the guard 10 is removed from the machine. This makes it easier to reinstall the guard 10 and more likely that an operator will reinstall the guard 10 before using the machine.

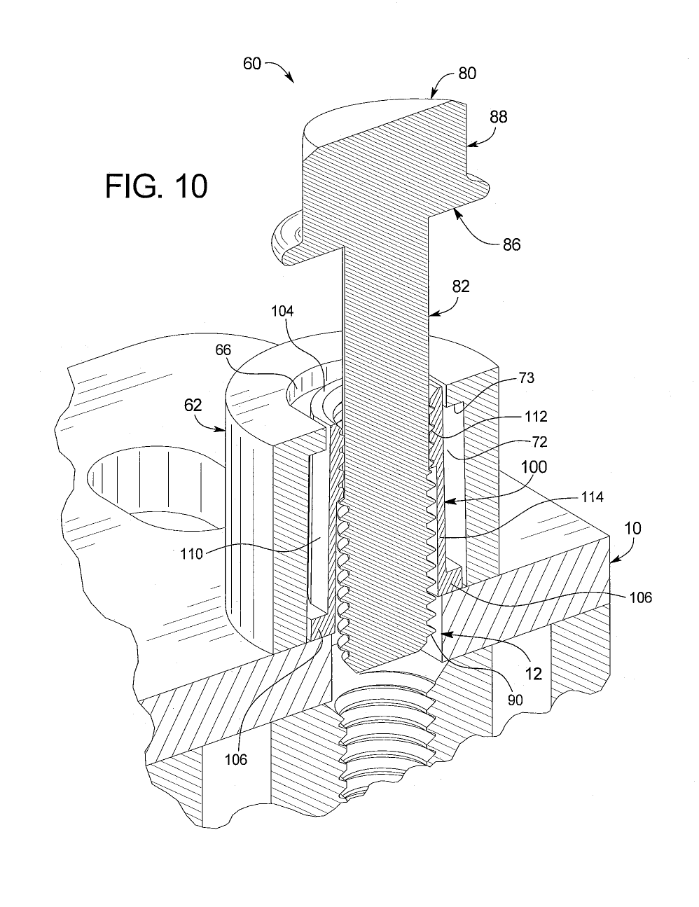

Unlike the nut fastener 20 described above, the screw 80 in the screw fastener 60 may be more easily removable from the sleeve 62 and the guard 10. This may make assembly of the screw fastener 60 easier and less expensive during manufacturing and may make it easier for an operator to replace the screw 80 if it becomes damaged. To install the screw fastener 60, the sleeve 62 is welded to the guard 10 as described above with the inner sleeve 100 captured within the sleeve 62. The contact surface 108 of the inner sleeve 100 contacts the surface of the guard 10 to prevent the inner sleeve 100 from passing through the slotted opening 12 in the guard 10. The retaining member 106 also prevents the inner sleeve 100 from fully passing through the slotted opening 66 in the sleeve 62. After the sleeve 62 and inner sleeve 100 are permanently attached to the guard 10, the threaded portion 90 of the screw 80 may be threaded through the inner threads 112 of the inner sleeve. The opposing flat sides 110 of the second end 104 of the inner sleeve 100 are particularly helpful when threading the screw 80 through the inner sleeve 100 because engagement between the flat sides 110 of the inner sleeve 100 and the slotted opening 66 in the sleeve 62 prevents the inner sleeve 100 from rotating during threading without needing to manually retain the inner sleeve 100. If desired, the threaded portion 90 of the screw 80 may be threaded entirely through the inner threads 112 of the inner sleeve 100 so that the threaded portion 90 no longer engages the inner threads 112. The screw 80 may now slide through the inner sleeve 100 since the inner threads 112 of the inner sleeve 100 need not engage the shaft portion 82 of the screw 80, and the internal portion 114 of the inner sleeve 100 need not engage the threaded portion 90 of the screw 80. Preferably, as shown in FIG. 10, the length of the threaded portion 90 of the screw 80 is approximately equal to or less than the length of the internal portion 114 of the inner sleeve 100 and the thickness of the guard 10. In this arrangement, the end of the screw 80 will not extend all the way through the slotted opening 66 and the guard 10 when the threaded portion 90 of the screw 80 is fully threaded through the inner threads 112 of the inner sleeve 100. Alternatively, if it is desirable to reduce the height of the screw fastener 60, the length of the threaded portion 90 of the screw 80 may be within a 25% range of the combined length of the shaft portion 82 of the screw 80 and the second end 104 of the inner sleeve 100. Because the total longitudinal movement of the screw 80 after it has been threaded through the inner threads 112 of the inner sleeve 100 is a combination of the sliding movement of the shaft portion 82 through the inner threads 112 and the sliding movement of the second end 104 through the slotted opening 66, this arrangement may provide a smaller overall height of the screw faster 60. Once the screw 80 has been fully threaded through the inner threads 112 of the inner sleeve 100, the inner threads 112 act to capture the screw 80 to prevent it from being separated from the guard 10 unless the screw 80 is fully unscrewed from the inner sleeve 100. At this stage, the screw 80 may slide relative to the inner sleeve 100, and the inner sleeve 100 may slide relative to the sleeve 62 as desired to position the screw 80 for engagement with a threaded hole or a nut welded to the machine.

While preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

I claim:

1. A fastener, comprising:
a plurality of wrench bearing surfaces;
a threaded portion coaxial with and rotationally fixed to said wrench bearing surfaces;
a first torque bearing surface rotationally fixed to said wrench bearing surfaces;
a sleeve comprising an attachment surface adapted to fixedly attach said sleeve to an apparatus, a second torque bearing surface oppositely disposed from said attachment surface, a slotted opening extending through said second torque bearing surface, and an undercut space larger in size than said slotted opening disposed under said slotted opening between said second torque bearing surface and said attachment surface, said second torque bearing surface being larger in size than said slotted opening and being adapted to engage said first torque bearing surface;
an insert portion extending through said slotted opening, said insert portion being coaxial with said wrench bearing surfaces, said insert portion being approximately equal in size to a width of said slotted opening to minimize lateral movement of said insert portion within said slotted opening, and said insert portion being smaller in size to a length of said slotted opening to allow movement of said insert portion along said length of said slotted opening;
a retaining member longitudinally restrained to said wrench bearing surfaces when said wrench bearing surfaces are moved longitudinally and not rotated, said retaining member disposed within said undercut space and being larger in size than a width of said slotted opening;
wherein said wrench bearing surfaces, said threaded portion, said first torque bearing surface, and said insert portion are prevented from being separated from said sleeve by said retaining member when said wrench bearing surfaces are not rotated, and longitudinal force is transmitted to said apparatus through said first torque bearing surface, said second torque bearing surface, said sleeve and said attachment surface when said wrench bearing surfaces are tightened.

2. The fastener according to claim 1, wherein said wrench bearing surfaces, said threaded portion, said first torque bearing surface, said insert portion and said retaining member comprise an integral nut, said threaded portion comprising internal threads.

3. The fastener according to claim 2, further comprising a washer disposed within said undercut space between said retaining member and said slotted opening and being larger in size than said width of said slotted opening.

4. The fastener according to claim 1, wherein said retaining member is a flange on an inner sleeve, said inner sleeve being longitudinally restrained to said wrench bearing surfaces when said wrench bearing surfaces are moved longitudinally and not rotated.

5. The fastener according to claim 4, wherein said inner sleeve comprises inner threads, said threaded portion of said screw being threadable through said inner threads of said inner sleeve.

6. The fastener according to claim 5, wherein said wrench bearing surfaces, said threaded portion and said first torque bearing surface comprise an integral screw, said threaded portion comprising external threads, said screw further comprising a shaft portion disposed between said first torque bearing surface and said threaded portion, said shaft portion being smaller in diameter than said inner threads of said inner sleeve, said shaft portion thereby being slidable through said inner threads.

7. The fastener according to claim 6, wherein said inner sleeve comprises a contact surface at a first end of said inner sleeve disposed away from said first torque bearing surface, said contact surface being adapted to contact a surface of said apparatus when said sleeve is fixedly attached to said apparatus, said contact surface being larger in size than a width of an apparatus slotted opening extending through said apparatus which said fastener is adapted for, said inner sleeve thereby being prevented from extending through said apparatus slotted opening when said sleeve is fixedly attached to said apparatus.

8. The fastener according to claim 7, wherein a width of said contact surface is approximately equal in size to a width of said undercut space to minimize lateral movement of said inner sleeve within said sleeve.

9. The fastener according to claim 8, wherein a length between said contact surface and a second end of said inner sleeve disposed toward said first torque bearing surface is at least as long as a distance between said attachment surface and said slotted opening, an end portion of said inner sleeve adjacent said second end thereby protruding through at least a portion of said slotted opening when said contact surface contacts said surface of said apparatus, said end portion forming said insert portion.

10. The fastener according to claim 9, wherein said end portion comprises opposing flat sides engaged with said width of said slotted opening, said inner sleeve thereby being rotationally fixed to said sleeve.

11. The fastener according to claim 10, wherein said end portion extends along a length of said inner sleeve greater than a depth of said slotted opening, said end portion thereby being slidable through said slotted opening and said second end of said inner sleeve being extendable past said second torque bearing surface, said opposing flat sides extending an entire length that said end portion is slidable through said slotted opening.

12. The fastener according to claim 11, wherein said flange is disposed at said first end of said inner sleeve thereby forming said contact surface and said end portion extends from said second end to said flange.

13. The fastener according to claim 12, wherein said inner threads of said inner sleeve are disposed adjacent said second end, said inner sleeve further comprising an internal portion disposed from said inner threads to said first end and being larger in size than said threaded portion, said threaded portion thereby being slidable through said internal portion.

14. The fastener according to claim 13, wherein a combined length of said shaft portion and said end portion is within a 25% range of a length of said threaded portion.

15. The fastener according to claim 1, wherein said threaded portion comprises external threads and said retaining member is a flange on an inner sleeve, said inner sleeve being longitudinally restrained to said wrench bearing surfaces when said wrench bearing surfaces are moved longitudinally and not rotated, said inner sleeve comprising a contact surface at a first end of said inner sleeve disposed away from said first torque bearing surface, said contact surface being adapted to contact a surface of said apparatus when said sleeve is fixedly attached to said apparatus, a length between said contact surface and a second end of said inner sleeve disposed toward said first torque bearing surface being at least as long as a distance between said attachment surface and said slotted opening, and an end portion of said inner sleeve adjacent said second end thereby protruding through at least a portion of said slotted opening when said contact surface contacts said surface of said apparatus, said end portion forming said insert portion, said end portion comprising opposing flat sides engaged with said width of said slotted opening, said inner sleeve thereby being rotationally fixed to said outer sleeve, said end portion extending along a length of said inner sleeve greater than a depth of said slotted opening, said end portion thereby being slidable through said slotted opening and said second end of said inner sleeve being extendable past said second torque bearing surface, and said opposing flat sides extending an entire length that said end portion is slidable through said slotted opening.

16. The fastener according to claim 15, wherein said wrench bearing surfaces, said threaded portion and said first torque bearing surface comprise an integral screw, said inner sleeve comprising inner threads, said threaded portion of said screw being threadable through said inner threads of said inner sleeve.

17. The fastener according to claim 16, wherein said screw further comprises a shaft portion disposed between said first torque bearing surface and said threaded portion, said shaft portion being smaller in diameter than said inner threads of said inner sleeve, said shaft portion thereby being slidable through said inner threads, said inner threads of said inner sleeve being disposed adjacent said second end, said inner sleeve further comprising an internal portion disposed from said inner threads to said first end and being larger in size than said threaded portion, said threaded portion thereby being slidable through said internal portion.

18. The fastener according to claim 17, wherein a combined length of said shaft portion and said end portion is within a 25% range of a length of said threaded portion.

19. The fastener according to claim 1, wherein said threaded portion comprises external threads and said retaining member is a flange on an inner sleeve, said inner sleeve being longitudinally restrained to said wrench bearing surfaces when said wrench bearing surfaces are moved longitudinally and not rotated, said inner sleeve comprising a contact surface at a first end of said inner sleeve disposed away from said first torque bearing surface, said contact surface being adapted to contact a surface of said apparatus when said sleeve is fixedly attached to said apparatus, said contact surface being larger in size than a width of an apparatus slotted opening extending through said apparatus which said fastener is adapted for, said inner sleeve thereby being prevented from extending through said apparatus slotted opening when said sleeve is fixedly attached to said apparatus, a width of said contact surface being approximately equal in size to a width of said undercut space to minimize lateral movement of said inner sleeve within said sleeve.

20. The fastener according to claim 19, wherein a length between said contact surface and a second end of said inner sleeve disposed toward said first torque bearing surface is at least as long as a distance between said attachment surface and said slotted opening, an end portion of said inner sleeve adjacent said second end thereby protruding through at least a portion of said slotted opening when said contact surface contacts said surface of said apparatus, said end portion forming said insert portion and comprising opposing flat sides engaged with said width of said slotted opening, said inner sleeve thereby being rotationally fixed to said sleeve, said end portion extending along a length of said inner sleeve greater than a depth of said slotted opening, said end portion thereby being slidable through said slotted opening and said second end of said inner sleeve being extendable past said second torque bearing surface, said opposing flat sides extending an entire length that said end portion is slidable through said slotted opening, said inner sleeve further comprising inner threads, said threaded portion of said screw being threadable through said inner threads of said inner sleeve, and further comprising a shaft portion disposed between said first torque bearing surface and said threaded portion, said shaft portion being smaller in diameter than said inner threads of said inner sleeve, said shaft portion thereby being slidable through said inner sleeve, said inner threads of said inner sleeve being disposed adjacent said second end, said inner sleeve further comprising an internal portion disposed from said inner threads to said first end and being larger in size than said threaded portion, said threaded portion thereby being slidable through said internal portion.
